(19) United States
(12) Patent Application Publication
(10) Pub. No.: US 2013/0241684 A1
(43) Pub. Date: Sep. 19, 2013

(54) METHOD FOR MANUFACTURING COMMON MODE FILTER AND COMMON MODE FILTER

(71) Applicants: Ju Hwan YANG, Suwon-si (KR); Won Chul SIM, Suwon-si (KR); Young Seuck YOO, Suwon-si (KR); Sung Kwon WI, Suwon-si (KR)

(72) Inventors: Ju Hwan YANG, Suwon-si (KR); Won Chul SIM, Suwon-si (KR); Young Seuck YOO, Suwon-si (KR); Sung Kwon WI, Suwon-si (KR)

(73) Assignee: SAMSUNG ELECTRO-MECHANICS CO., LTD., Suwon-si (KR)

(21) Appl. No.: 13/784,310

(22) Filed: Mar. 4, 2013

(30) Foreign Application Priority Data
Mar. 15, 2012 (KR) 10-2012-0026674

(51) Int. Cl. H01F 5/00; H01F 41/04

(52) U.S. Cl. CPC H01F 5/003; H01F 41/042
USPC 336/200; 205/125

(57) ABSTRACT

Disclosed herein are a method for manufacturing common mode filter and a common mode filter. The method includes: performing electroplating on first coil patterns made of a conductive material to form second coil patterns having a cross-sectional area increased as compared to the first coil patterns. Therefore, the common mode filter fulfilling a miniaturization demand and having the improved characteristics such as the inductance, the DC resistance, and the like, may be implemented.

### CROSS REFERENCE(S) TO RELATED APPLICATIONS

This application claims the benefit under 35 U.S.C. Section 119 of Korean Patent Application Serial No. 10-2012-0026674, entitled “Method for Manufacturing Common Mode Filter and Common Mode Filter” filed on Mar. 15, 2012, which is hereby incorporated by reference in its entirety into this application.

### BACKGROUND OF THE INVENTION

1. Technical Field

The present invention relates to a method for manufacturing common mode filter and a common mode filter.

2. Description of the Related Art

A common mode filter (CMF) is an electronic component widely used in various electronic devices in order to remove common mode noise.

Recently, in accordance with miniaturization, slimness, and multi-functionalization of electronic products, research into a CMF capable of improving noise removing performance and being miniaturized and thinned has been continuously conducted.

In addition, various researches and attempts have been conducted in order to improve characteristics such as an inductance, direct current (DC) resistance, and the like, of the CMF. An example of these researches and attempts includes a CMF capable of increasing a cutoff frequency and improving an impedance characteristic as disclosed in Patent document 1.

Meanwhile, a method for manufacturing a common mode filter using a photo-resist process that has been currently applied widely is schematically shown in FIG. 1.

Referring to FIG. 1, in a thin film type CMF according to the related art, a coil pattern may be formed in a scheme in which a metal seed layer 20 is formed on a magnetic substrate 10, a photo-resist is coated and developed on the metal seed layer 20 to form a photo-resist pattern 30, and a conductive material 40 such as copper, or the like, is then filled in a region exposed by the photo-resist pattern 30.

FIG. 2 is a view schematically showing a cross-section of a common mode filter according to the related art. Referring to FIG. 2, a relationship between a width w and a height h of a first coil pattern 50a, and a spaced distance d between adjacent coil patterns will be appreciated.

As shown in FIGS. 1 and 2, in the case of forming a photo-resist pattern in a general photo-resist process according to the related art, there is a limitation in decreasing a width of the pattern, or an interval between the adjacent patterns. In this case, in order to increase volume of the coil pattern while constantly maintaining the entire width of the common mode filter, the spaced distance d between adjacent coils should be decreased. However, since there is a limitation in decreasing the spaced distance d between the adjacent coils due to the limitation in the photo-resist process described above, there is a restriction in improving characteristics of the common mode filter without increasing the entire size of the common mode filter.

### RELATED ART DOCUMENT

### [Patent Document]

(Patent Document 1) Korean Patent Laid-Open Publication No. 10-2011-0082641

### SUMMARY OF THE INVENTION

An object of the present invention is to provide a method for manufacturing common mode filter and a common mode filter that are capable of improving characteristics such as an inductance, direct current resistance, and the like, by increasing volume of a coil pattern.

According to an exemplary embodiment of the present invention, there is provided a method for manufacturing a common mode filter, including: performing electroplating on first coil patterns made of a conductive material to form second coil patterns having a cross-sectional area increased as compared to the first coil patterns.

The method may further include performing wet etching on a product obtained by performing the electroplating on the first coil pattern.

According to another exemplary embodiment of the present invention, there is provided a method for manufacturing a common mode filter, including: applying power to a lead wire electrically connected to one end of each of a plurality of first coil patterns made of a conductive material and performing electroplating to form a plurality of second coil patterns having a cross-sectional area increased as compared to the plurality of first coil patterns.

The method may further include, after the forming of the plurality of second coil patterns, performing a dicing process so that the plurality of second coil patterns are separated from each other, respectively, wherein the dicing process is performed along a dicing line set so that the lead wire is separated from one end of each of the plurality of second coil patterns.

The method may further include, after the performing of the wet etching on the product obtained by performing the electroplating, performing a dicing process so that the plurality of second coil patterns are separated from each other, respectively, wherein the dicing process is performed along a dicing line set so that the lead wire is separated from one end of each of the plurality of second coil patterns.

According to still another exemplary embodiment of the present invention, there is provided a method for manufacturing a common mode filter, including: forming a seed metal layer on a surface of a substrate; forming a photo-resist pattern on the seed metal layer so that a surface of the seed metal layer is partially exposed; plating the exposed surface of the seed metal layer with a metal; removing the seed metal layer positioned beneath the photo-resist pattern and the photo-resist pattern to form first coil patterns, and performing electroplating on the first coil patterns to form second coil patterns having a cross-sectional area increased as compared to the first coil patterns.

The method may further include performing wet etching on the second coil pattern.

According to still another exemplary embodiment of the present invention, there is provided a method for manufacturing a common mode filter including: forming a seed metal layer on a surface of a substrate; forming a photo-resist pattern so as to expose a region in which a plurality of first coil patterns are formed and a region in which a lead wire electrically connected to one end of each of the plurality of first coil patterns is formed, on the seed metal layer; plating the exposed surface of the seed metal layer with; a metal; removing the seed metal layer positioned beneath the photo-resist pattern and the photo-resist pattern to form the plurality of first coil patterns and the lead wire; and applying power to the lead wire to perform electroplating on the plurality of first coil patterns, thereby forming a plurality of second coil patterns having a cross-sectional area increased as compared the plurality of first coil patterns.

The method may further include, after the forming of the plurality of second coil patterns, performing a dicing process so that the plurality of second coil patterns are separated from each other, respectively, wherein the dicing process is performed along a dicing line set so that the lead wire is separated from one end of each of the plurality of second coil patterns.

The method may further include, after the performing of the wet etching on the product obtained by performing the electroplating, performing a dicing process so that the plurality of second coil patterns are separated from each other, respectively, wherein the dicing process is performed along a dicing line set so that the lead wire is separated from one end of each of the plurality of second coil patterns.

According to still another exemplary embodiment of the present invention, there is provided a common mode filter including: coil patterns made of a conductive material and formed on a substrate made of a magnetic material, wherein the coil pattern has a cross-sectional shape in which surface thereof facing the substrate is flat and the other surface thereof is oval.

In the coil pattern, a ratio of a long side horizontal to the surface facing the substrate to a short side vertical to the long side may be 1.1 to 2:1.

In the coil pattern, a ratio of a maximum distance from the long side to the surface facing the substrate to a maximum distance from the long side to an upper surface of the coil pattern may be 6.5:3.5 to 5.5:4.5.

In the coil pattern, an interval between adjacent coils may be 0.15 to 0.45 times of a length of the long side of the coil pattern.

### BRIEF DESCRIPTION OF THE DRAWINGS

FIG. 1 is a view schematically showing a method for manufacturing a common mode filter (CMF) according to the related art; wherein FIG. 1A shows a step of providing a substrate, FIG. 1B shows a step of forming a seed metal layer, FIG. 1C shows a step of forming a photo-resist pattern, FIG. 1D shows a step of forming coil patterns, FIG. 1E shows a step of removing the photo-resist pattern, and FIG. 1F shows a step of removing the seed metal layer;

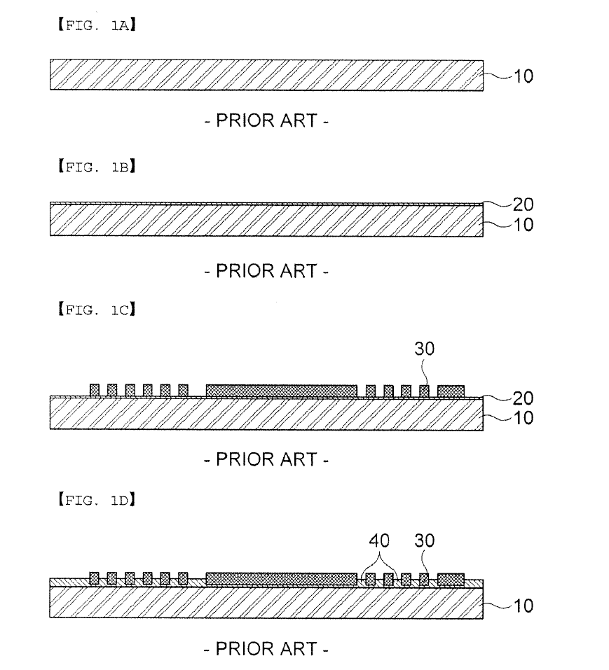

FIG. 2 is a view schematically showing a cross-section of the CMF according to the related art;

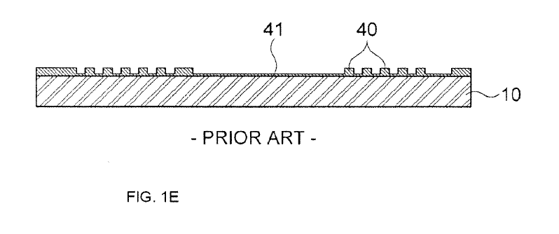

FIG. 3 is a view schematically showing a method for manufacturing a CMF according to an exemplary embodiment of the present invention; wherein FIG. 3A shows a step of providing a substrate, FIG. 3B shows a step of forming a seed metal layer, FIG. 3C shows a step of forming a photo-resist pattern, FIG. 3D shows a step of plating the seed metal layer exposed by the photo-resist pattern with a metal, FIG. 3E shows a step of removing the photo-resist pattern, FIG. 3F shows a step of removing the seed metal layer to form first coil patterns, and FIG. 3G shows a step of performing electroplating on the first coil patterns to form second coil patterns;

FIG. 4 is a view schematically showing a method for manufacturing a CMF according to another exemplary embodiment of the present invention; wherein FIG. 4A shows a step of providing a substrate, FIG. 4B shows a step of forming a seed metal layer, FIG. 4C shows a step of forming a photo-resist pattern, FIG. 4D shows a step of plating a metal on the seed metal layer exposed by the photo-resist pattern, FIG. 4E shows a step of removing the photo-resist pattern, FIG. 4F shows a step of removing the seed metal layer to form first coil patterns, FIG. 4G shows a step of performing electroplating on the first coil pattern, and FIG. 4H shows a step of performing wet etching on a product of the electroplating to form second coil patterns;

FIG. 5 is a view photographing a cross-section of the CMF according to another exemplary embodiment of the present invention;

FIG. 6 is a view schematically showing a cross-section of the CMF according to the exemplary embodiment of the present invention;

FIG. 7A is a view schematically showing a state in which a plurality of second coil patterns are connected to a lead wire in the method for manufacturing a CMF according to the exemplary embodiment of the present invention;

FIG. 7B is an enlarged view of the part V of FIG. 7A; and

FIG. 7C is a view schematically showing a state in which a dicing process is performed along a dicing line DL of FIG. 7B.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

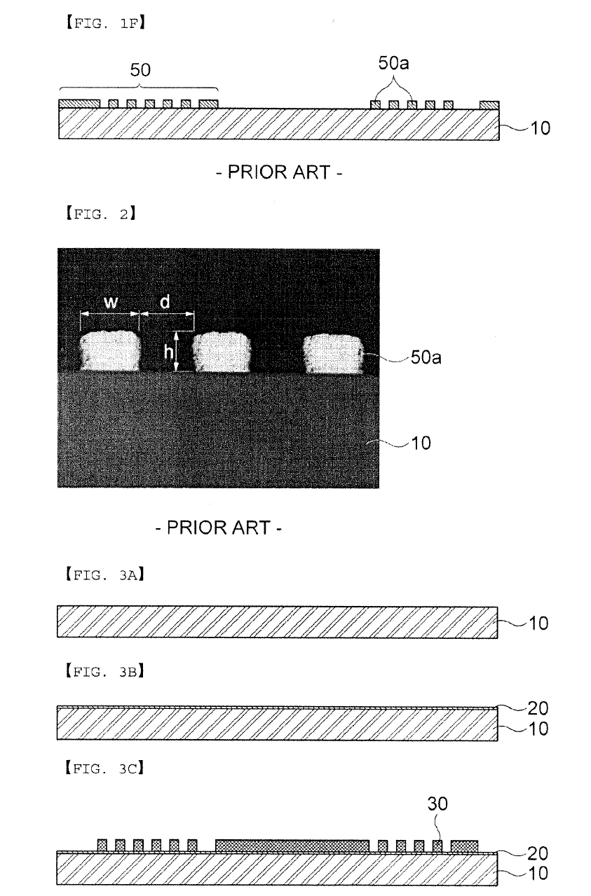

FIG. 3 is a view schematically showing a method for manufacturing a CMF according to an exemplary embodiment of the present invention; wherein FIG. 3A shows a step of providing a substrate 10, FIG. 3B shows a step of forming a seed metal layer 20, FIG. 3C shows a step of forming a photo-resist pattern 30, FIG. 3D shows a step of plating the seed metal layer 20 exposed by the photo-resist pattern 30 with a metal, FIG. 3E shows a step of removing the photo-resist pattern 30, FIG. 3F shows a step of removing the seed metal layer 20 to form first coil patterns 50 and 50a, and FIG. 3G shows a step of performing electroplating on the first coil patterns 50 and 50a to form second coil patterns 150 and 150a.

Referring to FIG. 3, the method for manufacturing a CMF according to the exemplary embodiment of the present invention includes a step of performing the electroplating on the first coil patterns 50 and 50a made of a conductive material 40 to form the second coil patterns 150 and 150a.

Here, the second coil patterns 150 and 150a are coil patterns having a cross-sectional area increased as compared to the first coil patterns 50 and 50a. That is, after the first coil patterns 50 and 50a are formed on the substrate 10 by various methods, such as printing, plating, and the like, power is applied to the first coil patterns 50 and 50a to perform the electroplating, thereby making it possible to increase the cross-sectional area and decrease a spaced distance between adjacent coils.

A method capable of being applied to the case of manufacturing a common mode filter by a photo-resist process will be described in more detail with reference to FIG. 3.

In the step of providing the substrate 10 shown in FIG. 3A, various magnetic substrates 10 required for manufacturing the common mode filter may be provided.

Then, the step of forming the seed metal layer 20 shown in FIG. 3B may be performed in a scheme in which a seed material for performing a subsequent plating process is formed on a surface of the substrate 10 by sputtering, or the like.

Next, in the step of forming the photo-resist pattern 30 shown in FIG. 3C, the photo-resist pattern 30 may be formed by applying a photo-resist material on the seed metal layer 20 and then removing a region to be plated.

Then, in the plating process shown in FIG. 3D, the conductive material 40 may be plated on a partial region of the seed metal layer 20 exposed by the photo-resist pattern 30 formed in the previous step.

Thereafter, as shown in FIG. 3E, the photo-resist pattern 30 is removed, and as shown in FIG. 3F, the seed metal layer portion 41 positioned beneath the photo-resist pattern 30 is removed, thereby making it possible to form the first coil patterns 50 and 50a.

Next, as shown in FIG. 3G, the electroplating is performed on the first coil patterns 50 and 50a to increase the cross-sectional areas of the coils, thereby making it possible to form the second coil patterns 150 and 150a.

Therefore, the common mode filter capable of decreasing a spaced distance between the adjacent coils and increasing volumes of the coils may be manufactured. As a result, the common mode filter improved in view of characteristics, such as inductance, direct current resistance, and the like, without an increase in the entire size thereof may be implemented.

Meanwhile, although not shown, a plurality of insulating layers, coil pattern layers, coil pattern layers, internal electrode terminals, external electrode terminals, a housing, and the like, may be included in the common mode filter in order to complete the common mode filter, which may be easily appreciated by those skilled in the art to which the present invention pertains. Therefore, an additional description thereof will be omitted.

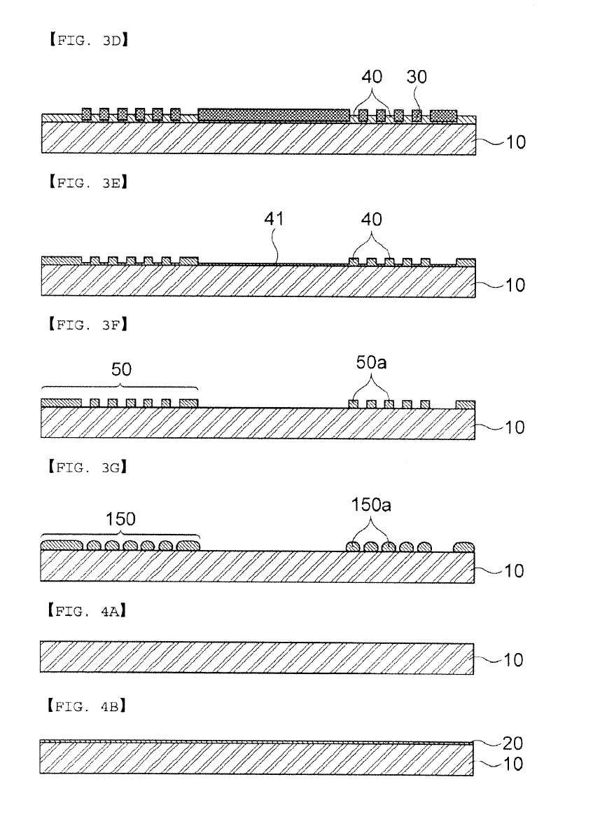

FIG. 4 is a view schematically showing a method for manufacturing a CMF according to another exemplary embodiment of the present invention; wherein FIG. 4A shows a step of providing a substrate 10, FIG. 4B shows a step of forming a seed metal layer 20, FIG. 4C shows a step of forming a photo-resist pattern 30, FIG. 4D shows a step of plating the seed metal layer 20 exposed by the photo-resist pattern 30 with a metal, FIG. 4E shows a step of removing the photo-resist pattern 30, FIG. 4F shows a step of removing the seed metal layer 20 to form first coil patterns 50 and 50a, FIG. 4G shows a step of performing electroplating on the first coil pattern 50 and 50a, and FIG. 4H shows a step of performing wet etching on a product of the electroplating to form second coil patterns 250 and 250a.

Since FIGS. 4A to 4G are the same as FIGS. 3A to 3G, an overlapped description of the related content will be omitted.

Referring to FIGS. 4G and 4H, it may be appreciated that when comparing cross-sectional areas of the second coil patterns 150 and 150a and the etched second coil patterns 250 and 250a with each other, the cross-sectional areas of the etched second coil patterns 250 and 250a are slightly decreased as compared to the second coil patterns 150 and 150a.

That is, referring to FIG. 4H for describing a state after the electroplating process is performed and the coils are wet-etched using hydrogen peroxide, sulfuric acid, and the like, in the case in which the coils are in contact with each other or a minimum spaced distance is not secured due to excessive performance of the electroplating process, the minimum spaced distance of the coils is secured by the wet etching, thereby making it possible to prevent generation of a short circuit.

In addition, since a surface of the coil may remain in a relatively rough state in the case of performing only the electroplating, the wet etching process is performed, thereby making it possible to smooth the surface of the coil.

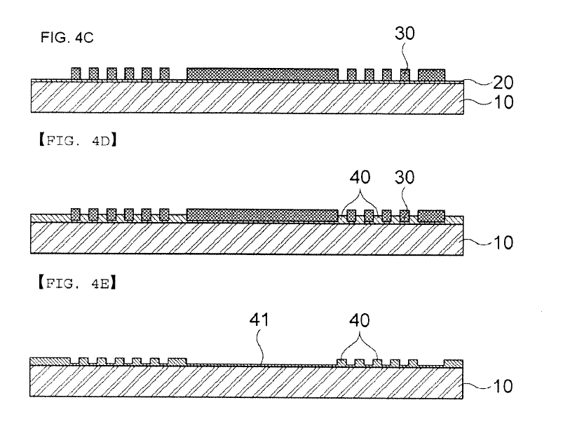

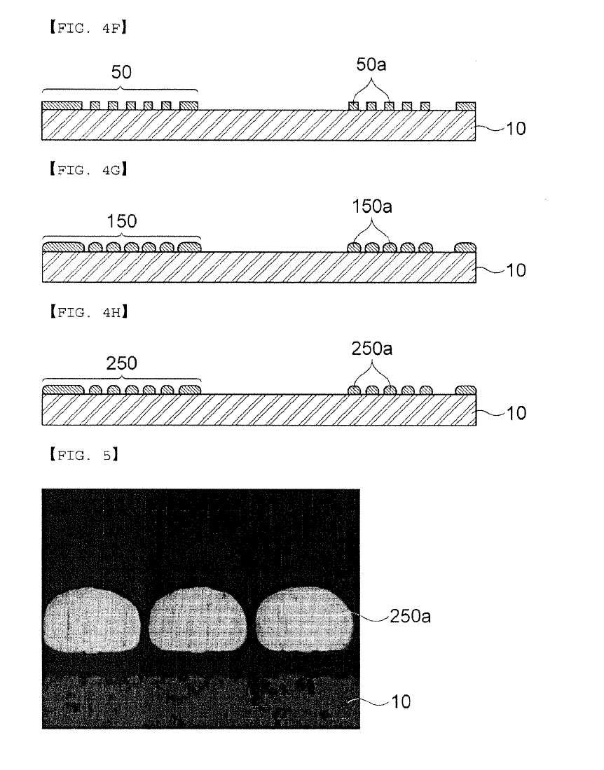

FIG. 5 is a view photographing a cross-section of the CMF according to another exemplary embodiment of the present invention, and FIG. 6 is a view schematically showing a cross-section of the CMF according to the exemplary embodiment of the present invention.

Referring to FIG. 6, the common mode filter according to the exemplary embodiment of the present invention generally has an oval shape and may include the second coil pattern 150a of which a surface facing the substrate 10 has a flat cross-sectional shape.

In this case, when a height h of the second coil pattern 150a is excessively high, it may be difficult for a common mode filter formed to have a multi-layer to be slimmed, and when a width w of the second coil pattern 150a is excessively wide, it may be difficult to secure sufficient turns in a common mode filter having a limited width

Therefore, the cross-sectional shape of the coil pattern may be formed in a range in which a ratio of a long side horizontal to the surface facing the substrate 10 to a short side vertical to the long side is 1.1 to 2:1.

Further, when an area of a contact surface between the second coil pattern 150a and the substrate 10 is excessively decreased, a phenomenon that the second coil pattern 150a is separated from the substrate 10 may occur to deteriorate reliability, and when the area of the contact surface between the second coil pattern 150a and the substrate 10 is excessively increased, a cross-sectional area and volume of the second coil pattern 150a may be decreased.

Therefore, the cross-sectional shape of the coil pattern may be formed in a range in which a ratio of a maximum distance from the long side to the surface facing the substrate 10 to a maximum distance from the long side to an upper surface of the coil pattern is 6.5:3.5 to 5.5:4.5.

In addition, a minimum spaced distance between adjacent coils needs to be satisfied in order to secure an insulation property therebetween. Further, the smaller the spaced distance, the larger the volume of the coil pattern.

Therefore, the cross-sectional shape of the coil pattern may be formed in a range in which an interval between the adjacent coils becomes 0.15 to 0.45 times of a length of the long side of the coil pattern.

Meanwhile, as shown in FIG. 6, the second coil pattern 150a may be implemented so as to contact an oxide layer 11, and the like, additionally provided on the substrate 10. A Fe component may be contained in a ferrite based magnetic substrate 10. In the case in which the interval between the coils is narrow, since an electric conduction phenomenon may be induced by a component such as Fe, or the like, an oxide layer 11, or the like, may be provided as an insulating layer in order to prevent this phenomenon.

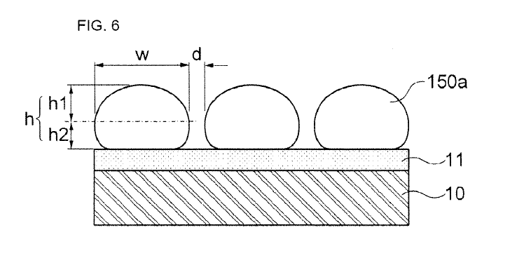

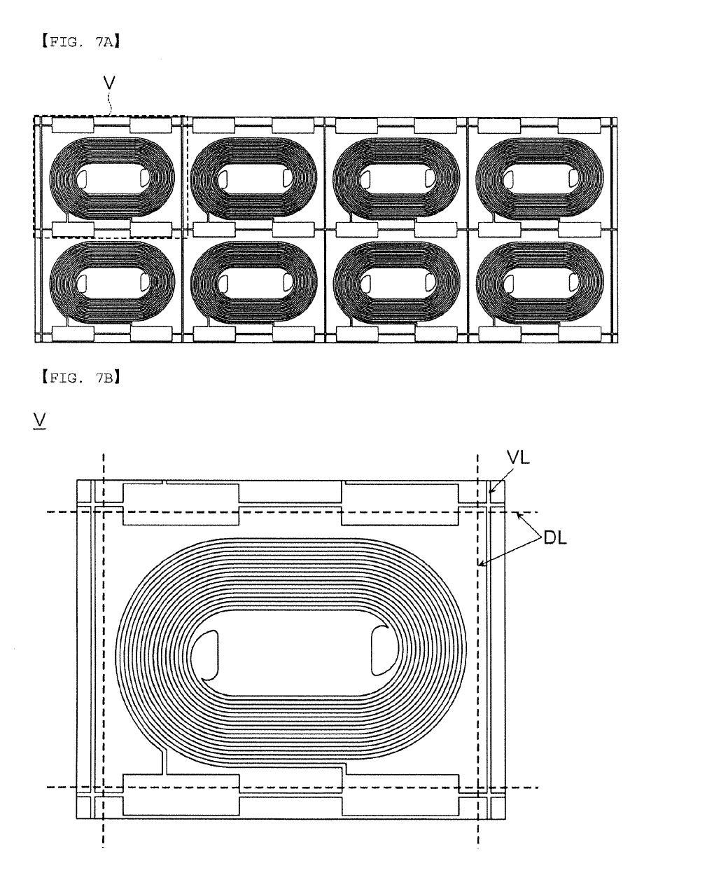

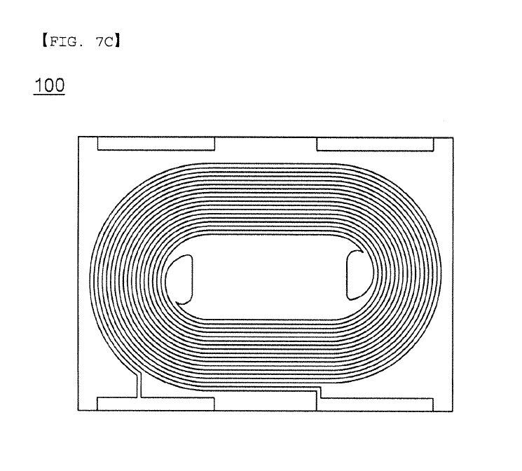

FIG. 7A is a view schematically showing a state in which a plurality of second coil patterns 150 and 150a are connected to a lead wire VL in the method for manufacturing a CMF according to the exemplary embodiment of the present invention, FIG. 7B is an enlarged view of the part V of FIG. 7A, and FIG. 7C is a view schematically showing a state in which a dicing process is performed along a dicing line DL of FIG. 7B.

Generally, in order to secure manufacturing efficiency of a common mode filter, a process of allowing a plurality of coil patterns for implementing a single common mode filter to be formed on one layer is performed as shown in FIG. 7A.

Meanwhile, in the method for manufacturing a common mode filter according to the exemplary embodiment of the present invention, the power is applied to the previously formed first coil patterns 50 and 50a to perform the electroplating.

Here, in the case in which the power is to be applied to each of the coil patters formed on the same layer, since power applying lines having the same number as that of coil patterns formed on one layer are required and each of the power applying lines needs to contact the coil patterns, a manufacturing facility is complicated and manufacturing efficiency is lowered.

In order to solve these problems, the power is applied by using a lead wire VL electrically connected to one end of each of the plurality of coil patterns in the present invention.

Referring to FIG. 7B, the lead wire VL enclosing the coil pattern at an outer portion of the coil pattern in a state in which it is spaced from the coil pattern by a predetermined distance may be provided together with the coil pattern.

A region in which the lead wire VL is to be formed together with the first coil patterns 50 and 50a is exposed by the photo-resist pattern 30 formed on the seed metal layer 20 and a subsequent process is then performed, thereby making it possible to implement the lead wire VL without addition of a manufacturing process or a decrease in manufacture efficiency.

In addition, the electroplating is performed by using the lead wire VL as shown in FIG. 7B, such that the electroplating may be more efficiently performed as compared to the case in which the lead wire VL is not used.

Meanwhile, in the case of implementing the lead wire VL so as to have a shape as shown in FIG. 7B, after a process of forming second coil patterns 150 and 150a on one layer are completed, a dicing process may be performed along a dicing line DL as shown in FIG. 7B, that is, a dicing line DL set so that the lead wire VL is separated from one end of each of a plurality of second coil patterns 150 and 150a.

As set forth above, the method for manufacturing a common mode filter according to the exemplary embodiments of the present invention configured as described above may solve problems according to the related art that there are limitations in increasing cross-sectional area of the coil pattern and at the same time, minimizing the interval between the adjacent coils, in the case of manufacturing the common mode filter by the photo-resist process.

That is, the electroplating is additionally performed on the previously formed first coil patterns, thereby making it possible to increase the cross-sectional area of the coil pattern and at the same time, minimize the interval between the adjacent coils.

Therefore, the common mode filter improved in view of the characteristics such as the inductance, the DC resistance, and the like, while fulfilling the miniaturization demand may be manufactured.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A method for manufacturing a common mode filter, the method comprising:
performing electroplating on first coil patterns made of a conductive material to form second coil patterns having a cross-sectional area increased as compared to the first coil patterns.

2. The method according to claim 1, further comprising performing wet etching on a product obtained by performing the electroplating on the first coil pattern.

3. A method for manufacturing a common mode filter, the method comprising:
applying power to a lead wire electrically connected to one end of each of a plurality of first coil patterns made of a conductive material and performing electroplating to form a plurality of second coil patterns having a cross-sectional area increased as compared to the plurality of first coil patterns.

4. The method according to claim 3, further comprising, after the forming of the plurality of second coil patterns, performing a dicing process so that the plurality of second coil patterns are separated from each other, respectively,
wherein the dicing process is performed along a dicing line set so that the lead wire is separated from one end of each of the plurality of second coil patterns.

5. The method according to claim 3, further comprising, after the performing of the wet etching on the product obtained by performing the electroplating, performing a dicing process so that the plurality of second coil patterns are separated from each other, respectively,
wherein the dicing process is performed along a dicing line set so that the lead wire is separated from one end of each of the plurality of second coil patterns.

6. A method for manufacturing a common mode filter, the method comprising:
forming a seed metal layer on a surface of a substrate;
forming a photo-resist pattern on the seed metal layer so that a surface of the seed metal layer is partially exposed;
plating the exposed surface of the seed metal layer with a metal;
removing the seed metal layer positioned beneath the photo-resist pattern and the photo-resist pattern to form first coil patterns, and
performing electroplating on the first coil patterns to form second coil patterns having a cross-sectional area increased as compared to the first coil patterns.

7. The method according to claim 6, further comprising performing wet etching on the second coil pattern.

8. A method for manufacturing a common mode filter, the method comprising:
forming a seed metal layer on a surface of a substrate;
forming a photo-resist pattern so as to expose a region in which a plurality of first coil patterns are formed and a region in which a lead wire electrically connected to one end of each of the plurality of first coil patterns is formed, on the seed metal layer;
plating the exposed surface of the seed metal layer with; a metal;
removing the seed metal layer positioned beneath the photo-resist pattern and the photo-resist pattern to form the plurality of first coil patterns and the lead wire; and
applying power to the lead wire to perform electroplating on the plurality of first coil patterns, thereby forming a plurality of second coil patterns having a cross-sectional area increased as compared the plurality of first coil patterns.

9. The method according to claim 8, further comprising, after the forming of the plurality of second coil patterns, performing a dicing process so that the plurality of second coil patterns are separated from each other, respectively,
wherein the dicing process is performed along a dicing line set so that the lead wire is separated from one end of each of the plurality of second coil patterns.

10. The method according to claim 8, further comprising, after the performing of the wet etching on the product obtained by performing the electroplating, performing a dicing process so that the plurality of second coil patterns are separated from each other, respectively,
wherein the dicing process is performed along a dicing line set so that the lead wire is separated from one end of each of the plurality of second coil patterns.

11. A common mode filter comprising:
coil patterns made of a conductive material and formed on a substrate made of a magnetic material,
wherein the coil pattern has a cross-sectional shape in which surface thereof facing the substrate is flat and the other surface thereof is oval.

12. The common mode filter according to claim 11, wherein in the coil pattern, a ratio of a long side horizontal to the surface facing the substrate to a short side vertical to the long side is 1.1 to 2:1.

13. The common mode filter according to claim 12, wherein in the coil pattern, a ratio of a maximum distance from the long side to the surface facing the substrate to a maximum distance from the long side to an upper surface of the coil pattern is 6.5:3.5 to 5.5:4.5.

14. The common mode filter according to claim 13, wherein in the coil pattern, an interval between adjacent coils is 0.15 to 0.45 times of a length of the long side of the coil pattern.
